(19) United States
(12) Patent Application Publication
(10) Pub. No.: US 2011/0028143 A1
(43) Pub. Date: Feb. 3, 2011

(54) METHOD AND APPARATUS OF LIST MANAGEMENT

(75) Inventors: Johan JOHANSSON, Kista (SE); Michael ROBERTS, Kista (SE); Boyun XIE, Shenzhen (CN)

Correspondence Address: Huawei Technologies Co., Ltd., IPR Dept., Building B1-3-A,, Huawei Industrial Base, Bantian, Shenzhen Guangdong, 518129, CN

(73) Assignee: HUAWEI TECHNOLOGIES CO., LTD., Shenzhen (CN)

(21) Appl. No.: 12/885,029

(22) Filed: Sep. 17, 2010

Related U.S. Application Data
(63) Continuation of application No. PCT/CN2009/070946, filed on Mar. 23, 2009.

(30) Foreign Application Priority Data
Mar. 24, 2008 (CN) 200810066189.9

(51) Int. Cl. H04W 8/00

(52) U.S. Cl. 455/422.1

(57) ABSTRACT

List management including storage and management of a CSG/PSG list in a user equipment is disclosed. The method of list management in user equipment of a wireless communication system includes storing a CSG/PSG list in the user equipment, and revising data entries in the CSG/PSG list according to network/cell related information input manually by a user of the equipment.

### CROSS-REFERENCE TO RELATED APPLICATIONS

This application is a continuation of International Application No. PCT/CN2009/070946, filed on Mar. 23, 2009, which claims priority to Chinese Patent Application No.200810066189.9, filed on Mar. 24, 2008, both of which are hereby incorporated by reference in their entireties.

### TECHNICAL FIELD

The present invention relates to mobile communication, and in particular, to a method and an apparatus of list management in a communication system.

### BACKGROUND

With the development of mobile communication technologies, more and more mobile communication systems come forth, such as Global System For Mobile Communication (GSM) which is also known as the 2^{nd} Generation (2G) mobile communication system, and Wideband Code Division Multiple Access (WCDMA), Code Division Multiple Access 2000 (CDMA2000), and Time Division-Synchronous CDMA (TD-SCDMA), which are also known as the 3^{rd} Generation (3G) mobile communication system, and the systems currently under development, e.g. Long Term Evolution (LTE) and World Interoperability for Microwave Access (WiMAX). The user's requirements are more diversified with the development of the mobile communication technologies, and more attention is paid to the system devices such as base stations for the home domestic coverage, or the enterprise-class internal coverage, as well as other restricted networks. In this context, example devices and networks are as follows: home Node B, home cell, access point, private network, private cell, and the restricted networks of some specific frequency layers.

The concepts of Closed Subscriber Group (CSG) and Prioritized Subscriber Group (PSG) have been introduced for private networks. A CSG network may include one or more cells. If a subscriber subscribes to a CSG or is added by the CSG administrator into the CSG, the subscriber is normally allowed to camp on a CSG cell and apply for services. The subscriber is normally unable to camp on the CSG cell or initiate a service otherwise. That is, the CSG network or cell only provides services for the CSG members, and Non-CSG members are not allowed to use any service of the CSG network or cell except emergency calls. In the PSG network, all terminals are allowed to camp on it, but the terminals are sorted according to priority. Therefore, some terminals in the connected state may be provided with better Quality of Service (QoS) or more types of service than other terminals. The terminal in the idle state may be judged to be preferential to camp on the cell of the PSG network if it has the higher priority. That is, only the PSG member can use the preferential services provided by the PSG network or cell, and non-PSG members are allowed to roam to the PSG network or cell, but cannot use the preferential services.

### SUMMARY

A method and apparatus of list management is disclosed in various embodiments of the present invention. According to an aspect of the invention, the problem of heavy load and cost of the core network nodes as described above may be reduced or eliminated.

An example list management method is disclosed in an embodiment of the present invention. The example method includes: storing, in a user equipment (UE), a CSG list and/or a PSG list; and managing, in the user equipment, the CSG list and/or PSG list according to the information input manually.

An example device is disclosed in an embodiment of the present invention. The device includes: a receiving unit, configured to receive information input by a user manually; a list storing unit, configured to store a CSG list and/or a PSG list; and a list managing unit, configured to manage content of the list storing unit according to the information received by the receiving unit.

In example embodiments of the present invention, the CSG list and/or PSG list in the terminal are/is preferably managed manually with assistance of existing signaling of the network, and/or without requiring massive modification of the core network nodes or increasing the signaling load of the core network nodes. Thereby, the cost of network upgrade may be reduced.

### BRIEF DESCRIPTION OF THE DRAWINGS

In order to make the technical solution under the present invention, the accompanying drawings for illustrating the embodiments of the present invention are outlined below. Evidently, the accompanying drawings are for the exemplary purpose only, and those skilled in the art can derive other drawings from such accompanying drawings without making any creative effort.

FIG. 1 shows a list management method according to an aspect of the present invention;

FIGS. 2a-2c illustrate various processing according to an embodiment of the present invention;

FIG. 3 shows an automatic search management method of CSG lists according to an embodiment of the present invention;

FIG. 4 shows a method of maintaining and managing a CSG list in a further embodiment of the present invention; and

FIG. 5 shows a UE in another embodiment of the present invention.

### DETAILED DESCRIPTION

The technical solution under the present invention is expounded below by reference to the accompanying drawings. The embodiments given herein are only part of all possible embodiments of the present invention. Those skilled in the art will be capable of deriving other embodiments from the embodiments given herein without need of any creative effort, and all such embodiments are within the scope of the present invention, and covered and protected thereby.

In an example system, such as an LTE system, a terminal may store a list of CSG networks or cells, which are accessible for the terminal. When the terminal approaches a CSG network or cell, it starts measuring the CSG network or cell, and judges whether the CSG network or cell is accessible. Alternatively, a terminal may store a list of PSG networks or cells in which the terminal can be treated as preferential user. When it approaches a PSG network or cell, the terminal starts measuring the PSG network or cell, and judges whether the terminal can be treated as a preferential user in the PSG network or cell.

The list of CSG or PSG networks or cells stored in a terminal is as a default maintained automatically. In the LTE system the management of the list can only be implemented through new messages, which are different from any existing signaling, between the terminal and the core network. Therefore, in order to support the functions of the private network according to the default, it is necessary to modify the nodes of the core network side massively, which will increase the load of the core network nodes and make the upgrade of the network or the device costly. Also, more signaling may load the air interface.

The list management method in the prior art involves modifications of the network nodes and cost of the necessary upgrade that is not suitable for legacy mature systems, such as Universal Mobile Telecommunications System (UMTS) and GSM EDGE Radio Access Network (GERAN).

In the embodiments of the present invention, the CSG list and/or the PSG list in the terminal are/is preferably managed manually with assistance of the existing signaling of the network, and/or without requiring massive modification of the core network nodes or increasing the signaling load of the core network nodes. Thereby, the cost of the network upgrade may be reduced.

In the embodiments of the present invention, the terminal stores one or more CSG lists and/or PSG lists. The CSG list is a list of CSG networks or cells accessible for the terminal, and the PSG list is a list of PSG networks or cells in which the terminal can be treated as a preferential user. The information that may be stored by the terminal includes, but is not limited to, CSG network identifier, PSG network identifier, CSG cell identifier, PSG cell identifier, location area identifier, tracking area identifier, CSG network or cell location information, PSG network or cell location information, CSG network or cell frequency information, PSG network or cell frequency information, adjacent macro cell information and other related information.

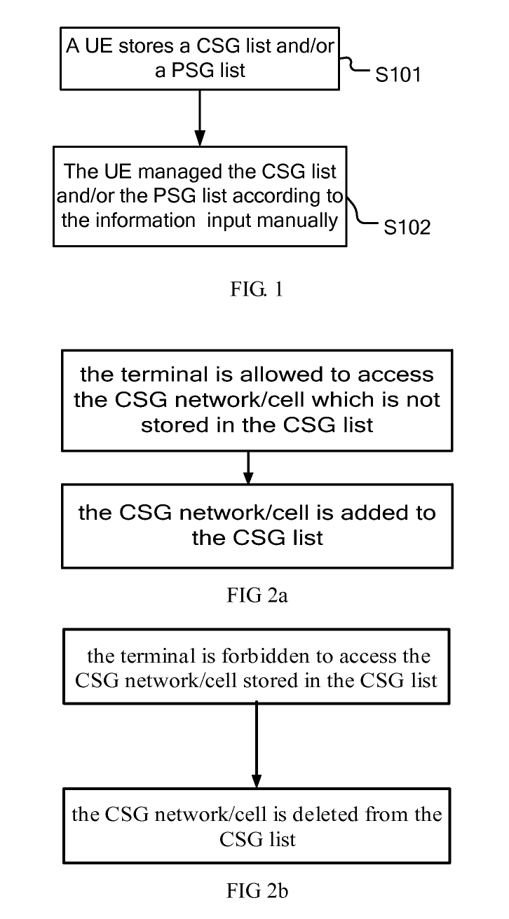

As shown in FIG. 1, a CSG and/or PSG list management method is disclosed according to an aspect of the present invention. The method includes:

S101: A UE stores a CSG list and/or a PSG list.

S102: The UE manages the CSG list and/or the PSG list according to the information input manually.

Further, in this embodiment, the UE may receive the information sent by the network side, and manage the CSG list and/or the PSG list according to the information input manually and the information sent by the network side.

In this embodiment, the CSG and/or PSG list may be managed manually without requiring massive modification of the core network nodes or increasing the signaling load of the core network nodes. The management includes: adding information to the list, deleting information from the list, and/or updating the information of the list. Therefore, the cost of network upgrade is reduced.

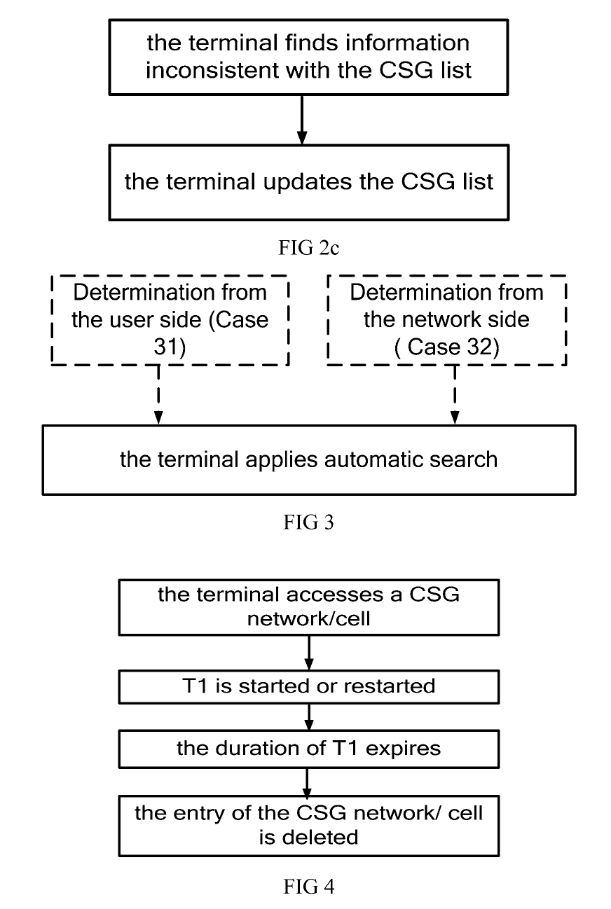

A CSG list management method is disclosed in a first embodiment of the present invention as illustrated in FIGS. 2a-2c.

In this embodiment, the CSG list is updated by the terminal, preferably manually, and it is preferred that the method is performed based on at least one of the following:

1. The CSG network or cell (or home basestation) supports manual selection, for example a string to identify a CSG cell may be delivered on a broadcast channel of the CSG cell, and the terminal is able to read the string and display it through a Man-Machine Interface (MMI);

2. A kind of message during an access control process, such as NAS message, may be sent between the terminal and the network side. Therefore, a Location Area (LA) or a Tracking Area (TA) of the CSG network or cell may be configured to be different from that of the macro cells. When the terminal searches the CSG cell or camps on the CSG cell, Location Area Update (LAU) or Tracking Area Update (TAU) is triggered. As a result, the terminal knows whether it is allowed to access the CSG cell, and updates the CSG list accordingly.

For example, the terminal may be notified, through a new Non-Access Stratum (NAS) message from the core network to the terminal, whether it is allowed or forbidden to access a CSG network or cell. Then the terminal adds the CSG network or cell to the CSG list or deletes the CSG network or cell from the CSG list accordingly.

A specific management method is as follows.

As shown in FIG. 2a, when the terminal is allowed to access the CSG network or cell, which is not stored in the CSG list, the CSG network or cell is added to the CSG list.

For example, cell A is a CSG cell and is not stored in the CSG list of the terminal. If the process of LAU or TAU initiated by the terminal in cell A is successful, the terminal confirms that it is allowed to access cell A.

If the process of LAU or TAU above is triggered manually, i.e. the user preferably uses the MMI of the terminal to manually input a command to trigger the process of LAU or TAU, the terminal stores the entry of cell A automatically in the CSG list after confirming that the terminal is allowed to access cell A.

If the process of LAU or TAU above is triggered in a non-manual mode, i.e. the user does not manually input a command to trigger the process of LAU or TAU, the terminal confirms whether it is allowed to access cell A. If yes, the terminal preferably displays the information about the accessibility through the MMI to inform the user. The user may then be prompted to store the entry of cell A in the CSG list or not, and perform the corresponding manual operations.

As shown in FIG. 2b, when the terminal is forbidden to access the CSG network or cell stored in the CSG list, the CSG network or cell is deleted from the CSG list.

For example, cell B is a CSG cell stored in the CSG list of the terminal.

If a process of LAU or TAU is initiated by the terminal in cell B through a NAS message sent to the network side, and the process is unsuccessful, e.g. the terminal receives a LAU or TAU rejection message after sending the NAS message, the terminal confirms that it is forbidden to access cell B.

If a process of Radio Resource Control (RRC) connection setup is initiated by the terminal through an RRC connection setup message sent to the network side or a reconstruction process is initiated by the terminal through a reconstruction message sent to the network side, and the process is unsuccessful, e.g. the terminal receives an RRC connection setup rejection message or has no response, the terminal confirms that it is forbidden to access cell B.

If a process of RRC connection release is initiated by the terminal through an RRC connection release message sent to the network side, and the terminal receives from the network side, a RRC connection release message carrying a release cause value indicating the terminal is forbidden to access, the terminal confirms that it is forbidden to access cell B.

If the foregoing process of LAU, TAU, connection or release is triggered by the user manually, i.e. the user uses the MMI of the terminal to manually input a command to trigger the foregoing process, the terminal deletes cell B automatically from the CSG list after confirming that the terminal is forbidden to access cell B.

If the foregoing process is triggered by the user in a non-manual mode, i.e. the user does not manually input a command to trigger the foregoing process, the terminal confirms whether it is forbidden to access cell B. If yes, the terminal displays the information about the rejection through an MMI to inform the user. The user has a choice to delete cell B from the CSG list or not, and perform the corresponding manual operations.

As shown in FIG. 2c, the terminal preferably updates the CSG list when it finds information inconsistent with the CSG list.

In a process of candidate search or manual search, if the terminal finds that the information about the CSG network or cell is inconsistent with the information stored in the CSG list, the terminal may verify the accuracy of the information, and choose whether to update the CSG list or not. Alternatively, the terminal may update the CSG list directly according to the newly discovered information without any verification.

Specifically, the user can decide to add or delete a CSG cell of the CSG list. For example, if the terminal is forbidden to access an example cell A′, which is not stored in its CSG list, the user may still decide to store the entry of cell A′ in its CSG list preferably as controlled through the MMI of the terminal. If the terminal is not allowed to access cell B′ stored in its CSG list, the user may decide to delete cell B′ from its CSG list and provide instructions preferably as controlled through the MMI of the terminal.

A PSG list management method is disclosed in the second embodiment of the present invention.

In this embodiment, the PSG list is updated by the terminal manually. On the one hand, the PSG network or cell supports manual selection. For example, a string to identify a CSG cell may be delivered through a broadcast channel of the PSG cell, and the terminal is able to identify the string and display it through an MMI; on the other hand, a kind of message during an access control process signaling, such as NAS message, may be sent between the terminal and the network side. Therefore, different LAs or TAs may be configured for the PSG network or cell. When the terminal searches the PSG cell or camps on the PSG cell, LAU or TAU (including periodical update) is triggered. The network side sends a NAS or RRC message carrying a preferential indication or non-preferential indication. In this way, the terminal knows whether it is a preferential user of the PSG network or cell, and updates the PSG list accordingly. The specific management method is as follows.

When the terminal is accepted as a preferential user to access the PSG network or cell which is not stored in the PSG list, the PSG network or cell is added to the PSG list.

For example, cell C is a PSG cell and is not stored in the PSG list of the terminal. If the terminal receives a preferential access indication indicating the terminal can preferentially access cell C, the terminal confirms that it can access cell C as a preferential user.

If the user receives the indication after the user's manual trigger, e.g. the user uses the MMI of the terminal to manually input a trigger, and the terminal receives the indication afterwards, the terminal preferably stores the entry of cell C in the PSG list automatically when the terminal confirms that it can access cell C as a preferential user. If the user receives the indication without any user's manual trigger, e.g. the user does not use the MMI of the terminal to manually input a trigger, the terminal displays the information about permission of accessing cell C as a preferential user to the user through the MMI. The user has a choice to store the entry of cell C in the PSG list or not, and perform the corresponding manual operations.

When the terminal is forbidden to access the PSG network or cell, stored in the PSG list, as a preferential user, the PSG network or cell is preferably deleted from the PSG list.

For example, cell D is a PSG cell stored in the PSG list of the terminal. When the terminal in cell D confirms that the terminal is not allowed to access or camp on the PSG cell as a preferential user, the terminal deletes the PSG from the PSG list. The indication may be carried by a LAU response or a TAU response. If the terminal initiates a process of LAU or TAU through a NAS message sent to the network side, and receives a response carrying a non-preferential access indication and/or a response carrying no preferential access indication, the terminal confirms that it is forbidden to access cell D as a preferential user. If the terminal initiates a RRC connection setup progress through an RRC connection setup message or a reconstruction process through a reconstruction message sent to the network side, and receives a response carrying a non-preferential access indication and/or a response carrying no preferential access indication, the terminal confirms that the terminal is forbidden to access cell D as a preferential user. If the terminal initiates an RRC connection release process through an RRC connection release message sent to the network side, and receives from the network side, an RRC connection release message carrying a release cause value indicating the preferential access is not allowed, the terminal confirms that the terminal is forbidden to access cell D as a preferential user.

If the foregoing process of update, connection or release is triggered by the user manually, i.e. the user uses the MMI of the terminal to manually input a command to trigger the foregoing process, the terminal deletes cell D automatically from the PSG list after confirming that the terminal is forbidden to access cell D as a preferential user.

If the foregoing process is triggered by the user in a non-manual mode, i.e. the user does not manually input a command to trigger the foregoing process, the terminal determines whether the terminal is forbidden to access cell D. If such is the case, the terminal displays the information about the rejection through the MMI to inform the user as a preferential user. The user has a choice to delete cell D from the PSG list, and perform the corresponding manual operations.

The terminal updates the PSG list when it finds information inconsistent with the PSG list.

In a process of candidate search or manual search, if the terminal finds that the information about the PSG network or cell is inconsistent with the information stored in the PSG list, the terminal may verify the accuracy of the information, and choose to update the PSG list or not. Alternatively, the terminal may update the PSG list directly according to the newly discovered information without any verification.

Specifically, the user can decide to add or delete a PSG cell of the PSG list. For example, if the terminal is forbidden to access cell C′, which is not stored in its PSG list, as a preferential user, the user may still decide to store the entry of cell C′ into its PSG list as a preferential user, through the MMI of the terminal. If the terminal is allowed to access cell D′ stored in its PSG list, the user may decide to delete the entry of cell B′ from its PSG list through the MMI of the terminal.

Besides, the categorization of users by the PSG network or cell is not limited to preferential users and non-preferential users. Preferential users of different priority levels may be set according to the actual conditions, and therefore, the preferential access indication, non-preferential access indication, and the priority level of the preferential user may be sent to the terminal in the independent messages, or in other messages.

In the first and the second embodiments of the present invention, the existing messages in the access network carry the information required for basic management such as adding information, deleting information, and updating a CSG and/or PSG list, without requiring massive modification of the core network nodes or increasing the signaling load of the core network nodes. Therefore, the cost of network upgrade may be reduced.

As shown in FIG. 3, an example automatic search management method of CSG lists is disclosed in a further embodiment of the present invention.

In this embodiment, before the cell reselection or cell access, the terminal may perform automatic search according to the information in the CSG list to confirm whether the access is allowed. Alternatively, the terminal uses other search modes, such as search according to neighboring cell list or manual search. The details of the method are as follows.

The user side determines whether the terminal applies automatic search.

The user may determine whether the terminal applies automatic search according to the actual conditions. If the decision is not to automatically search the CSG networks or cells in one or more CSG lists, the user may manually input the corresponding indications indicating the automatic search is not available. When the terminal confirms it is allowed to access a CSG network or cell, the user can still choose not to perform automatic search for the network or cell.

The network side determines whether the terminal applies automatic search.

The network side may determine whether the terminal applies the automatic search function according to the actual conditions, and deliver an indication indicating the terminal to apply automatic search or not on searching a CSG network or cell.

Specifically, the network side may deliver the indication through broadcast information, a NAS message, or an RRC dedicated signaling. The indication may be denoted by the content of one bit. For example, 0 indicates the automatic search is not available, 1 indicates the automatic search is available. Alternatively, the available automatic search may be indicated by sending an indication, and if there is no indication, the automatic search is not available. For example, sending of 1-bit information indicates the automatic search is available, and lack of sending the 1-bit information or the information sent being “null” indicates the automatic search is not available.

When the terminal adds or updates information in the CSG list, the terminal sets the automatic search function according to the indication delivered by the network side and its own indication. For example, if the network side allows the terminal to access a CSG cell and delivers an indication indicating the automatic search is available, but the user refuses to apply automatic search to the CSG cell, the user may store the entry of the CSG cell into the CSG list, and indicate the corresponding automatic search is disabled. In another example, the network side forbids the terminal to use a CSG cell, but when the terminal informs the user to delete the CSG cell from the CSG list, the user refuses the deletion through manual input. Therefore, the CSG list of the terminal still reserves the entry of the CSG cell, and indicates the corresponding automatic search is disabled.

It is understandable for those skilled in the art that the automatic search management method of the PSG list is similar to the automatic search management method of the CSG list described above.

In an embodiment of the present invention, the network side provides an indication of automatic search so that the user has more accurate information from the network side. With the indication of automatic search delivered by the network side, the user controls the terminal to access the network more conveniently and directly.

As shown in FIG. 4, a method of maintaining and managing a CSG list is disclosed in a further embodiment of the present invention.

In this embodiment, a timer (Ti) is set in the terminal, and the user sets duration of Ti according to the actual conditions, for example the duration is 3 months. When the terminal accesses a CSG network or cell for the first time, Ti is started. When the terminal accesses the CSG network/cell afterwards, Ti is reset. When the duration of Ti expires, the entry of the CSG network or cell is deleted from the CSG list, and Ti is deleted. It is understandable for those skilled in the art that the device on the network side may also set a timer, which is theoretically similar to the timer set by the terminal and is not repeated here any further.

A method of maintaining and managing a PSG list is disclosed in a further embodiment of the present invention.

In this embodiment, a timer (T2) is set in the terminal, and the user sets duration of T2 according to the actual conditions, for example the duration is 3 months. When the terminal accesses a PSG network or cell as a preferential user for the first time, T2 is started. When the terminal accesses the PSG network or cell as a preferential user afterwards, T2 is reset. When the duration of T2 expires, the entry of the PSG network or cell is deleted from the PSG list, and T2 is deleted. It is understandable for those skilled in the art that the device on the network side may also set a timer, which is theoretically similar to the timer set by the terminal and is not repeated here any further.

In the foregoing two embodiments, a timer is set. A network or cell in the CSG/PSG list may remain unavailable in a long period due to the unavailable private network or home basestation for a long time, and the network or cell may be deleted in time, thus the maintenance and management of lists is facilitated.

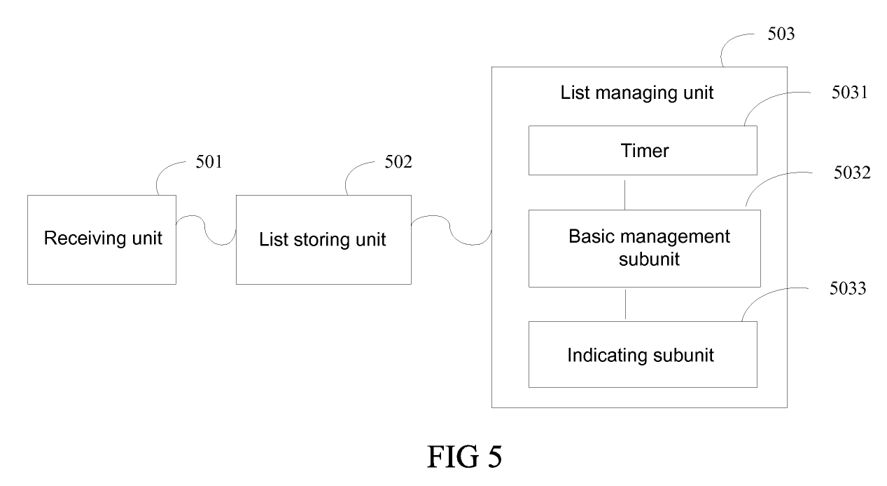

A UE is disclosed in a further embodiment of the present invention. As shown in FIG. 5, the UE includes a receiving unit 501, a list storing unit 502, and a list managing unit 503. The receiving unit 501 is configured to receive the information input by a user manually. Further, the receiving unit 501 may also be configured to receive the information sent by the network. The list storing unit 502 is configured to store one or more CSG lists and/or PSG lists. The list managing unit 503 is configured to manage the content of the list storing unit 502 according to the information received by the receiving unit 501.

The list managing unit 503 may further include a basic management subunit 5031, which is configured to add, delete or update information of the network or cell in the CSG list and/or the PSG list, and an indicating subunit 5032, which is configured to indicate whether to perform automatic search for the network or cell in the CSG list and/or PSG list. Further, the list managing unit 503 may include a timer 5033, which is configured to trigger the basic management subunit 5031 to delete the network or cell in the CSG list and/or the PSG list.

Although the invention has been described through some example embodiments, the invention is not limited to such embodiments. It is apparent that those skilled in the art can make modifications and variations to the invention without departing from the scope of the invention. The invention is intended to cover the modifications and variations provided that they fall in the scope of protection defined by the following claims or their equivalents.

What is claimed is:

1. A method of list management in user equipment of a wireless communication system, comprising:
storing, in the user equipment, a Closed/Prioritized Subscriber Group, CSG/PSG, list; and
revising, in said user equipment, data entries in said CSG/PSG list according to network/cell related information input manually by a user of the equipment.

2. The method of claim 1, further comprising:
receiving, in said user equipment, network/cell related information sent by a network side;
revising said CSG/PSG list according to said information input manually and said information sent by said network side.

3. The method of claim 2, wherein said managing said CSG/PSG list comprises:
when said information sent by said network side indicates said user equipment is allowed to access a CSG network/cell which is not stored in the CSG list, adding, by said user equipment, said CSG network/cell to the CSG list.

4. The method of claim 2, wherein said revising data entries of said CSG/PSG list comprises:
when said information sent by said network side indicates said user equipment is forbidden to access a CSG network/cell stored in said CSG list, deleting, by said user equipment, said CSG network/cell from the CSG list.

5. The method of claim 2, wherein said revising data entries of said CSG/PSG list comprises:
when said information sent by said network side indicates information of a CSG network/cell received by said user equipment is inconsistent with information of said CSG network/cell stored in the CSG list, updating, in said user equipment, the CSG list.

6. The method of claim 2, wherein said managing said CSG/PSG list comprises:
revising, in said user equipment, data entries of said CSG/PSG list corresponding to search according to a manual search.

7. The method of claim 2, wherein said managing said CSG/PSG list comprises:
revising, in said user equipment, data entries of said CSG/PSG list corresponding to search according to a neighbor cell list/stored frequency information.

8. The method of claim 2, wherein said managing said CSG/PSG list comprises:
when availability of autonomous search is indicated by said information sent by said network side, revising by said user equipment said CSG/PSG list as indicated corresponding to network/cell search.

9. The method of claim 2, wherein said revising said CSG/PSG list comprises at least one of:
when said information sent by said network side indicates said user equipment is allowed to access a PSG network/cell, which is not stored in said PSG list, as a preferential user, adding, in said user equipment, said PSG network/cell to the PSG list;
when said information sent by said network side indicates said user equipment is forbidden to access a PSG network/cell stored in the PSG list, as a preferential user, deleting, in said user equipment, said PSG network/cell from the PSG list;
when said information sent by said network side indicates information of a PSG network/cell received by said user equipment is inconsistent with information of said PSG network/cell stored in said PSG list, updating, in said user equipment, the PSG list.

10. The method of claim 2, wherein said information input manually comprises at least one of:
a command input manually to trigger a process of Location Area Update;
a command input manually to trigger a process of Tracking Area Update;
a command input manually to trigger a process of Radio Resource Control connection reestablish;
a command input manually to trigger a process of RRC connection release;
a command input manually to select whether to store information in said CSG/PSG list;
a command input manually to select whether to delete information from said CSG/PSG list; and
a command input manually to select whether to set automatic search available for said CSG/PSG list.

11. The method of claim 2, wherein said information sent by said network side comprises at least one of:
broadcast information;
Non-Access Stratum, NAS, message; and
RRC dedicated signaling.

12. The method of claim 11, wherein said NAS message comprises at least one of:
a response message sent by said network side in response to a process of LAU trigged by said user equipment; and
a response message sent by said network side in response to a process of TAU trigged by said user equipment.

13. The method of claim 1, wherein said information input manually comprises manual setting of a duration of a timer; and wherein the method further comprises:
(re-)starting said timer when said user equipment accesses a CSG/PSG network/cell, and deleting said CSG/PSG network/cell from said CSG/PSG list when said timer expires.

14. The method of claim 1,
wherein information stored in said CSG/PSG list comprises at least one of:
CSG/PSG network identifier;
CSG/PSG cell identifier;
Location Area identifier;
Tracking Area identifier;
location information of CSG/PSG network/cell;
frequency information of CSG/PSG network/cell; and
information of neighbor macro cell.

15. A device, comprising:
a receiving unit, configured to receive information input by a user manually;
a list storing unit, configured to store a Closed/Prioritized Subscriber Group, CSG/PSG, list; and
a list managing unit, configured to revise content of said list storing unit according to said information received by said receiving unit.

16. The device of claim 15, wherein said list managing unit comprises:
a basic management subunit, configured to add, delete or update information of said lists stored in said list storing unit; and/or
an indicating subunit, configured to indicate whether to perform automatic search for a network or cell in said CSG/PSG list.

17. The device of claim 16, wherein said list managing unit comprises:
a timer, configured to trigger said basic management subunit to delete a network/cell.
